(19) United States
(12) Patent Application Publication
(10) Pub. No.: US 2026/0140006 A1
(43) Pub. Date: May 21, 2026

(54) THERMAL INSULATION DIAPHRAGM FOR A PRESSURE SENSOR, PRESSURE SENSOR WITH THERMAL INSULATION DIAPHRAGM, AND PRODUCTION OF A PRESSURE SENSOR WITH THERMAL INSULATION DIAPHRAGM

(71) Applicant: Kistler Holding AG, Winterthur (CH)

(72) Inventors: Giovanni Mastrogiacomo, Zurich (CH); Hans Beat Maerki, Kollbrunn (CH); Christian Martin Schmid, Winterthur (CH); Ricardo Rodrigo, Winterthur (CH)

(21) Appl. No.: 19/392,631

(22) Filed: Nov. 18, 2025

(30) Foreign Application Priority Data
Nov. 21, 2024 (EP) 24214645.4

(51) Int. Cl. G01L 19/06; F16L 59/02

(52) U.S. Cl. CPC G01L 19/0681; F16L 59/028

(57) ABSTRACT

A thermal insulation diaphragm for a pressure sensor for determining the pressure of a fluid medium includes a diaphragm and a coating, wherein a diaphragm surface of the diaphragm faces the fluid medium when the thermal insulation diaphragm is in use. The coating includes a lamellar structure that includes a plurality of lamellae, wherein for a majority of the lamellae, a longitudinal extension of each lamella normal to a diaphragm plane is at most half of a transverse extension of the lamella parallel to the diaphragm plane.

### TECHNICAL FIELD

The invention relates to a thermal insulation diaphragm for a pressure sensor, a pressure sensor comprising a thermal insulation diaphragm, and the production of a pressure sensor comprising a thermal insulation diaphragm. A thermal insulation diaphragm comprises a diaphragm and a coating.

### BACKGROUND OF THE INVENTION

A diaphragm separates a fluid medium in a first chamber from a second chamber. In the field of pressure measurement technology, pressure sensors often comprise a diaphragm that separates a measuring arrangement, for example a measuring arrangement, from the fluid medium, for example a gaseous and/or liquid measuring medium whose pressure is to be determined. A diaphragm usually comprises a diaphragm surface that faces the fluid medium.

In the case of a pressure sensor, the pressure of the fluid medium acting on the area of the diaphragm is transmitted to a measuring arrangement with as little loss as possible. At the same time, the measuring arrangement can be located directly on the side of the diaphragm facing away from the fluid medium or can be connected to the diaphragm by means of an additional element, for example a fixed piston or a fluid medium or a gel, which transmits the pressure or a proportional force to the measuring arrangement.

If a sensor is used in environments with hot fluid media, for example in an internal combustion engine or furnaces or melting furnaces or in applications with process heat such as chemical and industrial processes, etc., high temperatures can damage the measuring arrangement. In this case, heat energy from the fluid medium is transferred through the diaphragm to the measuring arrangement and can destroy it or at least hinder the determination of pressure. For example, many piezoelectric measuring arrangements exhibit a pyroelectric effect, which, in addition to the mechanically induced piezoelectric charge separation, causes a further pyroelectric charge separation that adversely distorts the pressure measurement. The temperature at which a measuring arrangement is damaged depends on the type of measuring arrangement. This can be remedied by placing the measuring arrangement at a greater distance, for example by using a very long piston or a long hydraulic line for pressure transmission. However, such solutions require a disproportionate amount of space. In addition, a long piston or a long hydraulic line influences the natural frequency of the sensor.

In particular, arising temperature peaks can damage a measuring arrangement.

EP0145146A2 shows a pressure sensor comprising a diaphragm whose surface faces a fluid medium in a combustion area and deflects in response to the level of adjacent pressure. A second diaphragm is spaced apart from the first diaphragm and deflects in response to the deflection of the first diaphragm. The second diaphragm is designed to generate a signal indicating the deflection of the second diaphragm. A force transmission means or pressure transmission means, which may be either a fluid or a piston between the first and second diaphragms, transmits the movement of the first diaphragm to the second diaphragm and reduces heat transfer from the first diaphragm to the second diaphragm by means of a large geometric spacing. Here, the disadvantage is that said pressure sensor has significantly larger dimensions than a corresponding sensor without a first diaphragm and force transmission means.

### OBJECTS AND SUMMARY OF THE INVENTION

An object of the invention is to improve a diaphragm in such a way that the aforementioned disadvantages are reduced. A further object of the invention is to provide a diaphragm that delays the entry of heat energy through the diaphragm.

These objects are solved by the features described herein.

The invention relates to a thermal insulation diaphragm for a pressure sensor for determining the pressure of a fluid medium in a first space such as a first chamber. The thermal insulation diaphragm is designed to separate the first space from a second space such as the interior of a housing that elongates along a longitudinal axis. The thermal insulation diaphragm is designed to be largely parallel to a diaphragm plane. The diaphragm plane is defined by a first spatial axis and a second spatial axis. The first spatial axis and second spatial axis are linearly independent and form a two-dimensional coordinate system. A third spatial axis is arranged normal to the diaphragm plane and desirably is coincident with the longitudinal axis. The first spatial axis, second spatial axis, and third spatial axis form a three-dimensional coordinate system. The thermal insulation diaphragm comprises a diaphragm and a coating. When said thermal insulation diaphragm is used, a diaphragm surface of the diaphragm faces the fluid medium. A coating is arranged on the diaphragm surface.

According to the invention, the coating comprises a lamellar structure. For a majority of the lamellae, the longitudinal extension of the lamellae normal to the diaphragm plane is at most half of the transverse extension of the lamellae parallel to the diaphragm plane. As a result, the transverse-longitudinal ratio of the lamellae is at least 2, wherein the transverse direction is a direction parallel to the diaphragm plane and the longitudinal direction is parallel to the third spatial axis.

A lamellar structure is understood to be a structure that predominantly comprises lamellae. A lamella is a flat particle with a cross-to-length ratio of at least 2, which is predominantly separated from other lamellae by a boundary, for example a cavity. For example, a cavity comprises one or more hollow spaces or one or more interstices between the lamellae. The coating can therefore be described as a hybrid material with cavities and lamellae.

Having a majority of lamellae means that at least 50% of the particles are in the form of a lamella. Being predominantly separate means that more than 50% of the surface area of the lamellae is separated from other lamellae by a boundary, whereby the lamellae may comprise at least partially material bonding and/or force fitting and/or form fitting connections with each other. The term “and/or” is understood as a non-exclusive disjunction, also known as “inclusive or.” In a lamellar structure, lamellae are layered on top of each other in such a way that the lamellae are arranged as parallel as possible with their longer extension. Largely parallel is to be understood as a deviation of the direction of the longer extension of the lamellae of less than 30°.

The lamellar structure is characterized by low thermal conductivity, which is at least 50% lower than the thermal conductivity of the coated diaphragm. Thermal conductivity is standardized to a unit of length and is expressed in the unit W·(mK)⁻¹ (watts per meter per Kelvin). The thermal conductivity is not specified for a single layer, but refers to a macroscopic body.

Due to the hybrid material, heat spreads in a lamellar structure primarily along the longer dimension of the lamella. Said hybrid material comprising a lamellar structure therefore exhibits a directional thermal conductivity, which conducts heat better along the longer dimension of the lamellae than along the shorter dimension. However, said hybrid material exhibits a significantly lower overall thermal conductivity in every direction than a solid body made of the same material as the lamellae. A solid body is understood to be a body that has the same chemical composition as a lamella, but does not have a lamellar structure with cavities.

A thermal insulation diaphragm, i.e., a diaphragm comprising a coating with a lamellar structure on its diaphragm surface facing the fluid medium, therefore exhibits slower heat entry to the side of the diaphragm facing away from the fluid medium than an uncoated diaphragm of the same material and dimensions. This allows the diaphragm to protect the side facing away from the fluid medium from high temperatures for a longer period of time, which could damage elements on the side facing away from the fluid medium. This extends the service life of these elements compared to an uncoated diaphragm, for example measuring arrangements such as piezoelectric crystals or ceramics, piezoresistive materials or strain gauges, but also electronic components, insulators or other elements that are installed in pressure sensors in particular. In addition, undesirable temperature dependencies of measurement signals are reduced, such as those caused by the pyroelectric effect of some piezoelectric measuring elements. The coating comprising a lamellar structure also protects the material of the diaphragm itself from temperature peaks. The coating also has the advantage of slowing down the heat entry into the diaphragm itself.

The coating comprising a lamellar structure is more flexible than a corresponding solid body made of the same material. This allows the coating to be used for flexible elements, such as a diaphragm for a pressure sensor, without significantly reducing the flexibility of the thermal insulation diaphragm, especially in comparison to a diaphragm that would have a layer of the same thickness made of a solid body of the same material. It is preferable for the modulus of elasticity of the coating and the modulus of elasticity of the diaphragm to be of the same order of magnitude.

Advantageously, the lamellae are largely separated from one another. The coating comprises cavities. Cavities are hollow spaces or interstices or cracks/microcracks that have an extension of at least 0.2 μm and at least partially separate lamellae from one another. A cavity may contain air or another fluid medium or may also have a different chemical composition than a lamella. The separation is at least partially achieved by cavities in the coating. The cavities separate individual lamellae from one another, so that heat conduction from one lamella to the next lamella is reduced compared to a corresponding solid body.

As is customary with diaphragms for pressure sensors, a thermal insulation diaphragm is usually a flat element along the diaphragm plane. A third axis normal to the diaphragm plane is also referred to as the longitudinal axis. The lamellar structure of the coating is characterized by the fact that the majority of the lamellae are designed in a flat manner. The projected transverse extension (extension along the transverse direction, i.e., parallel to the diaphragm plane) of the flat lamella onto the diaphragm plane is at least twice the projected longitudinal extension of the lamella onto the third axis (longitudinal axis). Transverse extension and longitudinal extension are determined in accordance with ASTM E 3 (Standard Guide for Preparation of Metallographic Specimens) in conjunction with a microscopy technique such as light microscopy, scanning electron microscopy (SEM) or the like.

Such a coating can be advantageously applied by a thermal spraying process. In thermal spraying processes, thermally at least partially melted particles of a material strike a diaphragm surface, causing them to mechanically deform into flat lamellae on the diaphragm surface or on previously applied lamellae. Applying the at least partially melted particles to already solidified lamellae does not result in a material bonding connection, but rather in a force fitting/form fitting connection that forms through cavities such as gaps or voids that separate most of the lamellae from each other. Accordingly, the cavities run primarily parallel to the diaphragm plane. The particles exhibit a particle size between 5 μm and 120 μm, whereby the particle size is determined by laser diffraction.

In particular, thermal spraying refers to plasma spraying according to DIN EN ISO 14917:2017 Thermal spraying-Terminology, classification (ISO 14917:2017).

Advantageously, the diaphragm is made of a metallic material. Metallic materials usually have an intrinsically higher temperature resistance. It is particularly advantageous for the diaphragm to be made of a nickel-or cobalt-based alloy, as is common for pressure sensors used to determine high temperatures. The diaphragm has a particularly advantageous chromium content of more than 15 wt % (15 percent by weight).

The coating advantageously exhibits a coating thickness of at least 100 μm. The coating thickness, i.e., the layer thickness of the coating, or briefly referred to as thickness, is determined normal to the diaphragm plane. In general, the coating thickness of a coating is understood to be normal to the coated surface. Such a coating slows down the heat entry into the side facing away from the fluid medium, i.e., into the second space, by at least 10% compared to an uncoated identical diaphragm.

In one embodiment of the thermal insulation diaphragm, the coating comprises a metallic material, preferably a nickel-based self-fluxing alloy. The nickel-based self-fluxing alloy and equivalent self-fluxing alloys in the field of thermal spraying are described in DIN EN ISO 14920:2015. Said coating is preferably made of nickel, chromium, silicon, and boron, particularly preferably according to the ratio formula in weight percent (empirical formula) Ni₇₆Cr₁₅Si₅B₄. Alternatively, the coating comprises a nickel alloy with nickel as the main component and a high proportion of oxide formers such as aluminum, chromium, and yttrium, or a cobalt alloy with cobalt as the main component and a high proportion of oxide formers such as aluminum, chromium, and yttrium.

In a further alternative embodiment of the thermal insulation diaphragm, said coating comprises a ceramic material, preferably yttrium oxide-stabilized zirconium oxide. Yttrium oxide-stabilized zirconium oxide comprises at least 90 wt % zirconium oxide (ZrO₂) and 6 wt % to 8 wt % yttrium oxide Y₂O₃.

Alternatively, the coating of a thermal insulation diaphragm may also comprise a metallic material mentioned above and a ceramic material mentioned above. This can be produced, for example, by allowing particles of the metallic material and particles of the ceramic material in an at least partially melted condition to strike the surfaces to be coated, referred to as the coating surface, and solidify there.

In one embodiment of the thermal insulation diaphragm, an adhesion promoter layer is preferably arranged between the diaphragm surface and the coating. The adhesion promoter layer comprises nickel- and/or cobalt- and/or iron-based alloys, wherein the nickel- and/or cobalt- and/or iron-based alloys comprise additional elements with a high affinity for oxygen, such as aluminum and refractory metals. The standard molar enthalpy of formation (Standard Enthalpy of Formation of Solid Oxides at 298.15 K and 1 atm) of the additional elements must exhibit a high affinity for oxygen of less than −150 kJ/mol. The standard molar enthalpy of formation and affinity for oxygen are based on the published data from Boettinger, W., Kattner, U., Moon, K., and Perepezko, J. (2006), NIST Recommended Practice Guide: DTA and Heat-Flux DSC Measurements of Alloy Melting and Freezing, Elsevier, Kidlington. For example, said adhesion promoter layer is applied by thermal spraying and has a largely anisotropic structure. The adhesion promoter layer is advantageous because it improves the adhesion of the coating with its lamellar structure compared to a thermal insulation diaphragm where the coating is applied directly to the diaphragm. For example, said adhesion promoter layer can reduce the deviation in the thermal extension coefficients between the thermal insulation layer and the diaphragm.

Preferably, said diaphragm exhibits a thermal linear extension coefficient, or briefly referred to as diaphragm extension coefficient, in the temperature range between 20° C. and 100° C. of between 8·10⁻⁶ K⁻¹ and 15·10⁻⁶ K⁻¹. It is also preferred that the thermal linear extension coefficient of the coating, or coating extension coefficient, deviates by less than 40% from the diaphragm extension coefficient. This is advantageous because significantly different linear extension coefficients greater than 40% lead to high stresses between the diaphragm and the coating, especially when the diaphragm is exposed to significantly different temperatures, for example during storage compared to use in high-temperature applications. Stresses can lead to flaking of the coating and thus negatively affect the thermal insulation of the thermal insulation diaphragm or damage the thermal insulation diaphragm. Aligning the diaphragm extension coefficients with the coating extension coefficient with a maximum deviation of 40% is therefore advantageous for the temperature resistance of the coating.

Advantageously, the coating exhibits thermal conductivity in the diaphragm plane and thermal conductivity perpendicular to the diaphragm plane. Preferably, said thermal conductivity in the diaphragm plane is greater than the thermal conductivity perpendicular to the diaphragm plane. Thus, in addition to the reduced thermal conductivity due to cavities in the lamellar structure, heat transfer into the second space is also slowed down by the fact that the heat energy is primarily dissipated sideways along the diaphragm plane and is less efficiently conducted along the longitudinal axis to the diaphragm.

Generally, the diaphragm also exhibits thermal conductivity. The thermal conductivity of the diaphragm is greater than any thermal conductivity of the coating.

The invention also relates to a sensor for determining the pressure of a fluid medium. Said sensor exhibits an embodiment of a described thermal insulation diaphragm. The sensor comprises a pressure side end facing the fluid medium. Said sensor comprises a housing. In addition, the sensor comprises a measuring arrangement. Said fluid medium exerts pressure on the heat insulation diaphragm, which is in operative connection with the measuring arrangement. The heat insulation diaphragm slows down heat transfer from the fluid medium into an interior space of the housing, which is usually the second space that the diaphragm separates from the first space containing the fluid medium.

Advantageously, the thermal insulation diaphragm is arranged at a pressure side end of said sensor which faces the fluid medium. The measuring arrangement is hermetically separated from the fluid medium by the thermal insulation diaphragm. This is advantageously achieved by a material bonding connection between the housing and the thermal insulation diaphragm. The housing may have at least a partial housing coating which is identical to the coating of the thermal insulation diaphragm and merges into it. This has the advantage that heat transfer through the housing into the second chamber, or through parts of the housing facing the fluid medium, is also slowed down. The coating is applied mutatis mutandis to a housing surface. An adhesion promoter layer can be applied to a housing surface in advance, analogous to the corresponding embodiment of the thermal insulation diaphragm.

A sensor according to the invention is produced, for example, by performing at least the following steps. However, the production is not limited to the production method described and can also be carried out using techniques other than thermal spraying, for example, using 3D printing techniques, laser cladding, etc.

The production of a sensor comprising a thermal insulation diaphragm comprises at least the following sub-steps: providing a housing comprising a diaphragm, which diaphragm is arranged at a pressure side end of said sensor. Determining a coating surface, wherein the coating surface comprises at least the diaphragm surface. The coating surface can be roughened in advance, depending on the surface condition, by sandblasting, glass bead blasting, or similar processes. Applying a coating to the coating surface by means of thermal spraying. Metallic or ceramic particles are moved toward the coating surface. The particles are at least partially molten and strike the coating surface in at least partially molten state. The particles are deformed into lamellar shapes by their kinetic energy upon impact. The majority of the particles solidify in lamellar shapes and form lamellae of the lamellar structure of the coating.

Optionally, the production of a sensor comprising a thermal insulation diaphragm may also comprise a step in which the coating surface comprises at least part of a surface of the housing, referred to as the housing surface.

Optionally, the production of a sensor comprising a thermal insulation diaphragm may also include a step in which the coating surface is primarily provided at least partially with a bonding agent layer, wherein the adhesion promoter layer corresponds to the adhesion promoter layer of the corresponding embodiment of the thermal insulation diaphragm. Brief description of the figures drawings

In the following, the invention will be explained in more detail in exemplary embodiments with reference to figures.

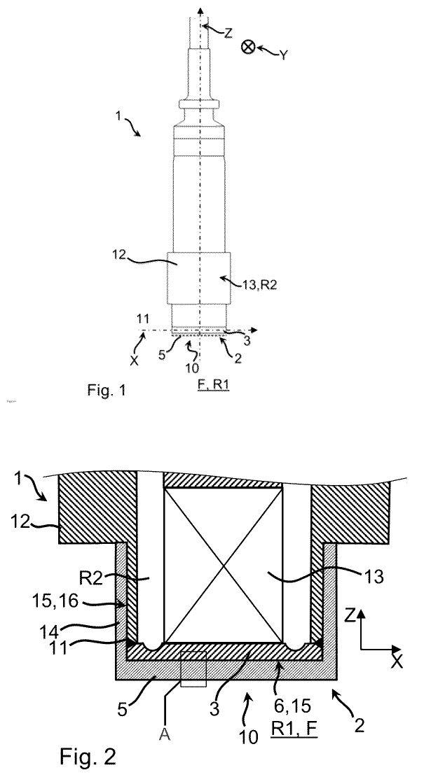

FIG. 1 shows a schematic view of a sensor comprising a thermal insulation diaphragm.

FIG. 2 shows a schematic cross-sectional view taken in the X-Z plane of a sensor comprising a first embodiment of a thermal insulation diaphragm.

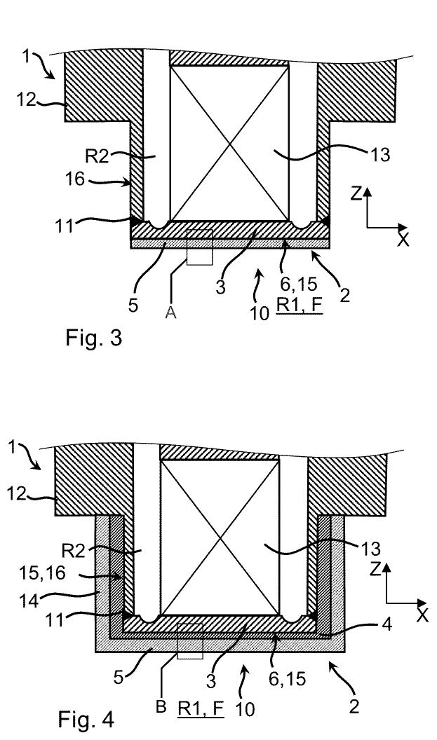

FIG. 3 shows a schematic cross-sectional view taken in the X-Z plane of a sensor comprising another embodiment of a thermal insulation diaphragm.

FIG. 4 shows a schematic cross-sectional view taken in the X-Z plane of a sensor comprising another embodiment of a thermal insulation diaphragm.

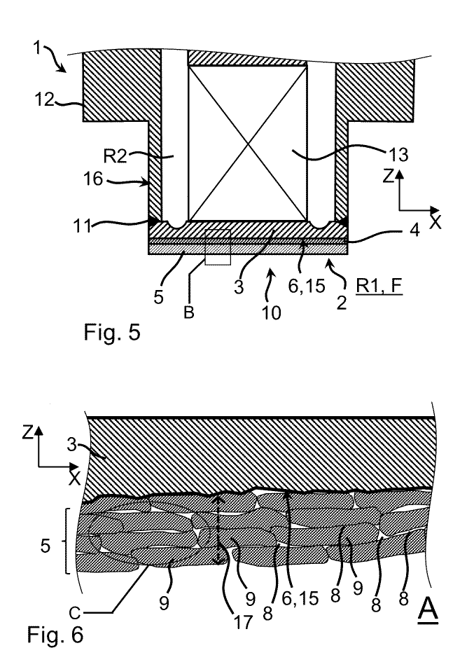

FIG. 5 shows a schematic cross-sectional view taken in the X-Z plane of a sensor comprising another embodiment of a thermal insulation diaphragm.

FIG. 6 shows a detail A of a cross-sectional view taken in the X-Z plane of an embodiment according to FIG. 2 or FIG. 3 of a thermal insulation diaphragm.

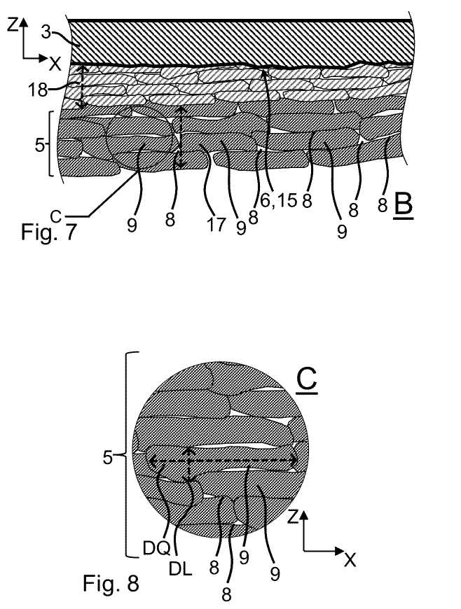

FIG. 7 shows a detail B of a cross-sectional view taken in the X-Z plane of an embodiment according to FIG. 4 or FIG. 5 of a thermal insulation diaphragm.

FIG. 8 shows detail C of a cross-sectional view taken in the X-Z plane of a thermal insulation diaphragm according to FIG. 6 or FIG. 7.

FIG. 9 shows a cross-sectional view taken in the X-Z plane to illustrate a schematic representation of the production of a thermal insulation diaphragm.

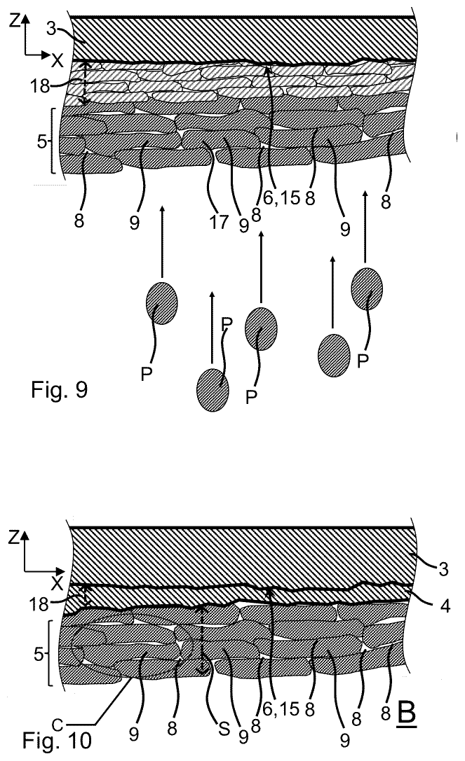

FIG. 10 shows a cross-sectional view taken in the X-Z plane of detail B according to FIG. 4 or FIG. 5 of a further embodiment of a thermal insulation diaphragm.

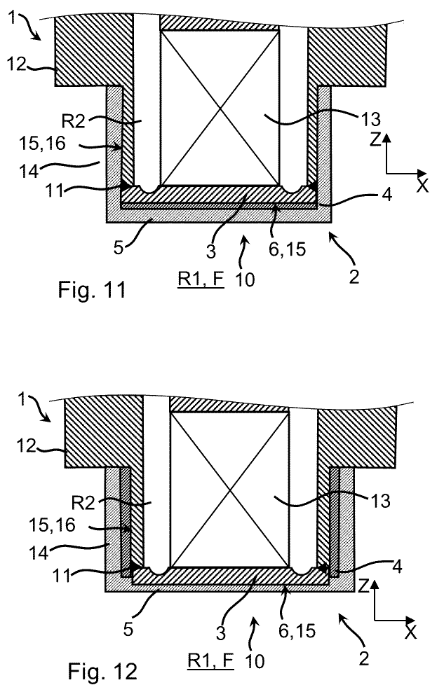

FIG. 11 shows a schematic cross-sectional view taken in the X-Z plane of a sensor comprising another embodiment of a thermal insulation diaphragm.

FIG. 12 shows a schematic cross-sectional view taken in the X-Z plane of a sensor comprising another embodiment of a thermal insulation diaphragm.

### DETAILED DESCRIPTION OF EXEMPLARY EMBODIMENTS WAYS OF CARRYING OUT THE INVENTION

FIG. 1 shows a schematic representation of a sensor 1 comprising a thermal insulation diaphragm 2. Said sensor 1 is designed to determine the pressure of the fluid medium F in the first chamber R1. Said sensor 1 comprises a pressure side end 10 facing the fluid medium F. In addition, sensor 1 comprises a housing 12 that defines a generally cylindrical shape with a hollow interior. Inside the sensor and not visible in FIG. 1, said sensor 1 comprises a measuring arrangement 13. Said measuring arrangement is located in the second chamber R2 within the hollow interior of the housing 12. The thermal insulation diaphragm 2 is located at the pressure side end 10. The sensor extends along the third axis Z, also referred to as the longitudinal axis Z. Said thermal insulation diaphragm 2 is designed to be disposed to lie largely parallel to the diaphragm plane XY, which lies normal to the longitudinal axis, whereby the diaphragm plane XY is defined by the first spatial axis X and a second spatial axis Y, which second spatial axis extends into the drawing plane. The thermal insulation diaphragm is shown as diaphragm 3 with a coating 5 (shown as a dashed line).

FIG. 2 represents a detail of a sensor 1 in a schematic cross-sectional view with a first embodiment of a thermal insulation diaphragm 2. Said thermal insulation diaphragm 2 comprises a diaphragm 3 and a coating 5. The diaphragm surface 6 of diaphragm 3 faces the fluid medium F when the thermal insulation diaphragm 2 or the sensor 1 is used. Said coating 5 is arranged on the diaphragm surface 6.

All embodiments shown in the figures are schematic representations. Dimensions, in particular thicknesses, coating thicknesses, lengths, etc., are chosen solely for better visibility and are not to be understood as specifications for the dimensioning of elements, nor for the dimensioning of elements in relation to one another.

FIG. 2 shows a schematic cross-sectional view of the sensor 1 comprising a first embodiment of the thermal insulation diaphragm 2. The schematic cross-sectional view shows a section of a partial view of said sensor 1 from FIG. 1 along the first axis X and the third axis Z. The measuring arrangement 13 is arranged in the second chamber R2 in the housing 12. For example, a measuring arrangement comprises a piezoelectric crystal or a piezoelectric ceramic, or other piezoresistive material or strain gauges, which are operatively connected to a diaphragm 3 and which produce a measurable electrical signal when force or pressure is applied at the pressure side end 10 of the sensor 1. The thermal insulation diaphragm 2 comprises a diaphragm 3 and a coating 5. As is usual with sensors 1, said diaphragm 3 is arranged at the pressure side end 10 of said sensor 1, and the outer peripheral region of the diaphragm is connected to the housing 12 of the sensor, for example by means of a material bonding connection 11 such as a welded joint, a soldered joint, or the like. However, diaphragm 3 can also be designed integrally with said housing 12, and the invention is by no means limited to a two-piece design but explicitly includes an assembly of diaphragm 3 and housing 12, being integrally formed as a unitary structure. Said thermal insulation diaphragm 2 is configured and disposed to transmit a pressure of a fluid medium F in the first chamber R1 to the measuring arrangement 13. Therefore, said thermal insulation diaphragm 2 is in operative connection with the measuring arrangement 13. In this embodiment, the coating 5 extends both over the diaphragm 2 and over parts of the housing 12 and transitions seamlessly from the diaphragm 2 to parts of the housing 12. It is understood that lamellae 9 comprising the coating 5, as shown in FIGS. 6 and 8, are each aligned with their longer transverse extension DQ largely parallel to the coated surface 15, and thus the spatial alignment of the transverse dimension changes at the transition from the diaphragm surface 6 to the surface of the housing 12. While the transverse dimension of the lamellae 9 on the diaphragm surface is

largely parallel to the first axis X and second axis Y (normal to the drawing plane in FIG. 2), the transverse dimension of the lamellae 9 of the coating of the housing 12 is largely parallel to the third axis Z.

In this and subsequent embodiments of the thermal insulation diaphragm 2, identical reference numerals indicate identical elements in the embodiments.

FIG. 3 shows a schematic cross-sectional view of a sensor 1 comprising a further embodiment of a thermal insulation diaphragm 2. The embodiment differs from the embodiment of FIG. 2 only in the coating 5. In this embodiment of FIG. 3, said coating 5 extends to the diaphragm surface 6. The housing 12 does not comprise a coating. This is particularly advantageous for front-sealing sensors in which the fluid medium does not come into contact with the housing 12, or only to a small extent, when said sensor 1 is in use.

FIG. 4 shows a schematic cross-sectional view of a sensor 1 comprising a further embodiment of a thermal insulation diaphragm 2. Likewise, in this embodiment of said thermal insulation diaphragm 2, the same reference numerals denote the same elements as in the embodiments shown previously. In this embodiment, an additional adhesion promoter layer 4 is applied between the coating 5 and the diaphragm 3. The adhesion promoter layer 4 improves the adhesion of the coating 5 to the surface 6 of said diaphragm 3. Said adhesion promoter layer 4 is optional and can be omitted for economic reasons if the adhesion of the coating 5 to the surface 6 of the diaphragm 3 is sufficient for the respective application. In this embodiment, the adhesion promoter layer 4 extends over both the diaphragm surface 6 and the housing surface 16. Thus, the adhesion promoter layer 4 is arranged between the diaphragm surface 6 and the coating surface 15 of the coating 5.

FIG. 5 shows a schematic cross-sectional view of a sensor 1 comprising a further embodiment of a thermal insulation diaphragm 2. Likewise, in this embodiment of the thermal insulation diaphragm 2, the same reference numerals denote the same elements as in the embodiments shown in FIGS. 2 to 4. The embodiment of FIG. 5 differs from the embodiment of FIG. 4 only in the coating 5 and the adhesion promoter layer 4. In this embodiment of FIG. 5, both the adhesion promoter layer 4 and the coating 5 extend onto the diaphragm surface 6. Said housing 12 does not comprise a coating. Analogous to the embodiment of the thermal insulation diaphragm 2 in FIG. 3, this is particularly advantageous for front-sealing sensors in which the fluid medium does not come into contact with housing 12, or only to a small extent, when said sensor 1 is in use.

FIG. 6 schematically shows a detail A of the coating 5, which schematically shows both the coating 5 for the embodiment of the thermal insulation diaphragm 2 according to FIG. 2 and the embodiment of the thermal insulation diaphragm 2 according to FIG. 3. Accordingly, the section of detail A is shown in both FIG. 2 and FIG. 3. The lamellae 9 shown in FIGS. 6 and 8 are arranged on said diaphragm 3. It should be noted that this is a schematic representation and neither the number of lamellae 9 nor the transverse extension DQ or longitudinal extension DL nor their ratio to each other constitutes a limitation. According to the invention, the ratio of transverse extension DQ/longitudinal extension DL of the majority of the lamellae 9 is at least 2. The coating 5 comprises cavities 8 which largely limit the lamellae 9 to each other. The coating 5 is shown in a coating thickness 17 which is measured normal to the coating surface and from the diaphragm surface 6 of said diaphragm 3.

FIG. 7 schematically shows a detail B of the coating 5, which schematically shows both the coating 5 for the embodiment of the thermal insulation diaphragm 2 according to FIG. 4 and the embodiment of the thermal insulation diaphragm 2 according to FIG. 5. Accordingly, the section of detail B is shown in both FIG. 4 and FIG. 5. The lamellae 9 shown in FIGS. 7 and 8 are arranged on said diaphragm 3. It should be noted that this is a schematic representation and neither the number of lamellae 9 nor the transverse extension or longitudinal extension nor their ratio to each other constitutes a limitation. According to the invention, the ratio of transverse extension DQ/longitudinal extension DL of the majority of the lamellae is at least 2. The coating 5 comprises cavities 8 which largely limit the lamellae 9 to each other. Cavities 8 are, for example, hollow spaces 8 or interstices 8, as is schematically shown in FIG. 7. The adhesion promoter layer 4 is arranged between coating 5 and diaphragm 3. The representation of the adhesion promoter layer 4 and the cavities 8 is also schematic and is not intended to represent any dimension or size ratio to diaphragm 3 or lamellae 9. In the representation in FIG. 7, the adhesion promoter layer 4 also comprises a lamellar structure. The adhesion promoter layer 4 can also be applied by thermal spraying in the same way as coating 5 and differs from coating 5 only in its material. The purely schematic representation in FIG. 7 does not allow any explicit conclusions to be drawn about size ratios. Coating 5 is shown with a coating thickness 17 measured normal to the coating surface and from the adhesion promoter layer 4. Coating thickness 17 is understood to be the average thickness of coating 5. The adhesion promoter layer thickness 18 is measured in the same way as coating thickness 17 and can be determined using the same method.

An alternative adhesion promoter layer 4 is schematically shown in FIG. 10. The adhesion promoter layer 4 does not comprise a lamellar structure and can be applied, for example, by vapor deposition, other physical vapor deposition techniques, or laser cladding, or can be produced by sintering thermally sprayed layers of self-flowing alloys.

It should be noted that, of course, at least one further layer may also be arranged between the adhesion promoter layer 4 and said diaphragm 3 shown in FIGS. 4, 5, 7, and 10. The adhesion promoter layer 4 does not necessarily have to be in direct contact with the diaphragm 3.

FIG. 8 schematically shows a detail C of the coating 5, which schematically shows both the coating 5 for all embodiments of the thermal insulation diaphragm 2 according to FIG. 6 and the embodiment of the thermal insulation diaphragm 2 according to FIG. 7. Accordingly, the section of detail C is shown in both FIG. 6 and FIG. 7. FIG. 8 schematically shows how the longitudinal extension DL of the lamellae 9 and the transverse extension DQ are to be determined. FIG. 8 shows the lamellae 9 of the lamellar coating 5 in a sectional view. However, the transverse extension DQ of the lamellae 9 is largely the same in every direction parallel to the diaphragm plane XY. The lamellae 9 have a largely oblate shape with the transverse extension DQ as the longer dimension. The longitudinal extension DL is determined perpendicular to the coating surface 15. The transverse extension DQ is determined parallel to the coating surface 15. If the coating 5 is arranged on the diaphragm surface 6, possibly with an intermediate adhesion promoter layer 4, the transverse dimension is parallel to the diaphragm plane XY and the longitudinal dimension is parallel to the third axis Z, also referred to as longitudinal axis Z.

The adhesion promoter layer 4 of the embodiment shown in FIG. 7 is largely analogous in its lamellae's physical shape to the physical shape of the lamellae in coating 5 of FIG. 8 and differs primarily in the choice of material.

For all embodiments shown, the majority of the lamellae 9 are flat in the sense that the projected transverse extension DQ of the flat lamella 9 on the diaphragm plane XY is at least twice the projected longitudinal extension DL of the lamella on the third axis Z, also referred to as longitudinal axis Z.

In all embodiments of the thermal insulation diaphragm 2 shown, said coating 5 comprises a coating thickness 17 of at least 100 μm. The coating thickness 17 of the coating 5 is measured in a direction that is normal to the coating surface 15. In the case of a coating 5 on the diaphragm surface 5, this is normal to the diaphragm plane XY, and in the case of a coating on the housing 12, it is normal to the respective housing surface 16.

The coating 5 of all embodiments of the thermal insulation diaphragm 2 shown may be applied by a thermal spraying process, as is schematically shown in FIG. 9. The particles P of material being sprayed to form the coating 5, tend to flatten on impact, and take on the shape of the lamellae 9.

The production of said sensor 1 with a thermal insulation diaphragm according to any of the described embodiments comprises at least the following sub-steps, some of which are schematically shown in FIG. 9. FIG. 9 shows a cross-section of a partial region of a diaphragm 3 which has been provided at a pressure side end 10 (not shown, analogous to FIG. 1) of said sensor 1 (not shown, analogous to FIG. 1). The coating surface 15 is defined, which in this exemplary embodiment comprises at least the diaphragm surface 6. Said coating 5 is applied to the coating surface 15 by means of thermal spraying, whereby metallic or ceramic particles P are moved in the direction of the coating surface 15, as indicated by the arrows on the particles P. The particles P are at least partially molten and strike the coating surface 15 in at least partially molten state. The particles P deform into a lamellar shape due to their kinetic energy upon impact and solidify mostly in a lamellar shape, forming lamellae 9 of the lamellar structure 7 of the coating 5.

The embodiments of the thermal insulation diaphragm 2 disclosed in this document can, of course, be combined with each another. This document also explicitly includes embodiments that feature a combination of the characteristics described herein.

In particular, an embodiment of a sensor 1 with a thermal insulation diaphragm 2 is also possible, in which an adhesion promoter layer 4 is arranged between said diaphragm 3 and the coating 5, but in which no adhesion promoter layer 4 is arranged between the housing 12 or housing surface 16 and the coating 5, as shown schematically in FIG. 11. Alternatively, an embodiment of a sensor 1 with a thermal insulation diaphragm 2 is also possible, in which an adhesion promoter layer 4 is arranged between the housing 12 or housing surface 16 and the coating 5, but in which no adhesion promoter layer 4 is arranged between said diaphragm 3 and the coating 5, as is schematically shown in FIG. 12.

### List of Reference Symbols

1 Sensor, pressure sensor
2 Thermal insulation diaphragm
3 Diaphragm
4 Adhesion promoter layer
5 Coating
6 Diaphragm surface
7 Lamellar structure
8 Cavity, hollow space, interstice
9 Lamella
10 Pressure side end
11 Material bonding connection
12 Housing
13 Measuring arrangement, sensor
14 Housing coating
15 Coating surface
16 Housing surface
17 Coating thickness, layer thickness, thickness
18 Adhesion promoter layer thickness
DQ Transverse extension
DL Longitudinal extension
F Fluid medium
P Particle
R1 First chamber
R2 Second chamber
X First spatial axis, first transversal axis
XY Diaphragm plane
Y Second spatial axis, second transversal axis
Z Third spatial axis, longitudinal axis

What is claimed is:

1. A thermal insulation diaphragm for a pressure sensor for determining the pressure of a fluid medium in a first chamber to which an exterior of a housing of the sensor is exposed; wherein the sensor is defined to elongate along a longitudinal axis and defines a second chamber internally of the housing; the thermal insulation diaphragm comprising:
a diaphragm configured to extend largely normal to the longitudinal axis and defining a diaphragm surface configured to face toward the first chamber and away from the second chamber;
a coating disposed on the diaphragm surface;
wherein said coating is defined by a lamellar structure that includes a plurality of lamellae;
wherein each respective lamella in a majority of the lamellae is defined by a longitudinal extension and a transverse extension, wherein the longitudinal extension is configured and disposed to lie parallel to the longitudinal axis, wherein the transverse extension is configured and disposed to lie normal to the longitudinal axis, wherein the longitudinal extension is at most half of the transverse extension of the respective lamella in the majority of the lamellae.

2. Thermal insulation diaphragm according to claim 1, wherein the coating comprises cavities in the form of hollow spaces defined in the coating; wherein the lamellae are largely separated from one another by a separation that is at least partially achieved by the cavities in the coating.

3. Thermal insulation diaphragm according to claim 1, wherein the majority of the lamellae are designed in a flat manner so that a projected transverse extension of the flat lamella onto a diaphragm plane, which is disposed to lie in a plane that is normal to the longitudinal axis, is at least twice a projected longitudinal extension of the flat lamella onto the longitudinal axis.

4. Thermal insulation diaphragm according to claim 1, wherein the coating has been applied to the diaphragm surface by a thermal spraying process.

5. Thermal insulation diaphragm according to claim 1, wherein the diaphragm is made of a metallic material that has a chromium content of more than 15% by weight.

6. Thermal insulation diaphragm according to claim 5, wherein the metallic material is a nickel-based alloy.

7. Thermal insulation diaphragm according to claim 5, wherein the metallic material is a cobalt-based alloy.

8. Thermal insulation diaphragm according to claim 1, wherein the coating is defined by a coating thickness of at least 100μm measured in a direction parallel to the longitudinal axis.

9. Thermal insulation diaphragm according to claim 1, wherein the coating comprises a metallic material.

10. Thermal insulation diaphragm according to claim 9, wherein the coating comprises a nickel-based self-fluxing alloy.

11. Thermal insulation diaphragm according to claim 9, wherein the coating comprises a nickel alloy with a high proportion of oxide formers consisting of one or more of: aluminum, chromium, and yttrium.

12. Thermal insulation diaphragm according to claim 9, wherein the coating comprises a cobalt alloy with a high proportion of oxide formers consisting of one or more of: aluminum, chromium, and yttrium.

13. Thermal insulation diaphragm according to claim 1, wherein the coating comprises a ceramic material or a metallic material and a ceramic material.

14. Thermal insulation diaphragm according to claim 13, wherein the coating includes yttrium oxide-stabilized zirconium oxide.

15. Thermal insulation diaphragm according to claim 1, further comprising an adhesion promoter layer disposed between the diaphragm surface and said coating; wherein the adhesion promoter layer comprises a metallic alloy that includes one or more selected from the list of: nickel, cobalt and iron; wherein the metallic alloy includes an additive element with a high affinity for oxygen; wherein the standard formation enthalpy of the additive element with a high affinity for oxygen must be less than −150 kJ/mol.

16. Thermal insulation diaphragm according to claim 1, wherein the diaphragm exhibits a thermal linear expansion coefficient in the temperature range of from 20° C. to 100° C. of 8·10⁻⁶ K⁻¹ to 15·10⁻⁶ K⁻¹; wherein the coating exhibits a thermal linear expansion coefficient; and wherein the thermal linear expansion coefficient of the coating deviates by less than 40% from the thermal linear expansion coefficient of the diaphragm.

17. Thermal insulation diaphragm according to claim 1, wherein a thermal conductivity of the coating in a direction normal to the longitudinal axis is greater than a thermal conductivity of the coating in a direction parallel to the longitudinal axis.

18. Thermal insulation diaphragm according to claim 1, wherein the coating exhibits a thermal conductivity; wherein the diaphragm exhibits a thermal conductivity; and wherein the thermal conductivity of said diaphragm is greater than the thermal conductivity of the coating.

19. A sensor for determining the pressure of a fluid medium; the sensor comprising:
a housing elongating along a longitudinal axis and defining an interior space and a pressure side end configured for facing the fluid medium;
a measuring arrangement disposed in the interior space defined by the housing;
a thermal insulation diaphragm according to any of the preceding claims disposed at the pressure side end of the housing and coupled to the measurement arrangement;
wherein the thermal insulation diaphragm includes:
a diaphragm configured to extend largely normal to the longitudinal axis and defining a diaphragm surface configured to face away from the interior space and the measuring arrangement;
a coating is arranged on the diaphragm surface;
wherein said coating is defined by a lamellar structure that includes lamellae;
wherein a majority of the lamellae are defined by a longitudinal extension and a transverse extension, wherein the longitudinal extension is configured and disposed to lie parallel to the longitudinal axis, wherein the transverse extension is configured and disposed to lie normal to the longitudinal axis, wherein the longitudinal extension is at most half of the transverse extension of the lamella.

20. The sensor according to claim 19; wherein the thermal insulation diaphragm is configured to hermetically seal the pressure side end of the housing and prevent the measuring arrangement from contact with the fluid medium;
wherein the housing and the thermal insulation diaphragm are connected by a material bond;
wherein said housing comprises a housing coating which is designed in the same way as the coating of the thermal insulation diaphragm and merges into the coating of the thermal insulation diaphragm.

21. A method of producing a sensor, the method comprising:
providing a housing comprising a diaphragm that defines a diaphragm surface, which diaphragm is arranged with the diaphragm surface facing toward a pressure side end of the sensor;
determining a coating surface that defines at least the diaphragm surface;
applying a coating to the coating surface by means of thermal spraying, wherein metallic or ceramic particles are moved in the direction of the coating surface; wherein said metallic or ceramic particles are applied in at least a partially molten state and strike the coating surface in the at least partially molten state;
wherein said particles are deformed into a lamellar shape by their kinetic energy upon impact with the coating surface;
wherein the majority of the particles solidify in a lamellar shape and form lamellae of a lamellar structure of the coating.
